(19) United States
(12) Patent Application Publication
(10) Pub. No.: US 2007/0168358 A1
(43) Pub. Date: Jul. 19, 2007

(54) Method of rewarding value

(76) Inventor: Yong Chen, Auckland (NZ)

Correspondence Address: YOUNG & THOMPSON, 745 SOUTH 23RD STREET, 2ND FLOOR, ARLINGTON, VA, 22202, US

(21) Appl. No.: 11/639,292

(22) Filed: Dec. 15, 2006

(30) Foreign Application Priority Data
Dec. 15, 2005 (NZ) 544183

(51) Int. Cl. G06F 17/30

(52) U.S. Cl. 707/10

(57) ABSTRACT

The invention consists in a method of rewarding value and comprising the steps of inviting users to a communications network to submit queries to an answer providing service for a fee. The quality of the query is determined and the user is offered a reward or payment dependent on the quality of the query.

This invention relates to a method of rewarding value particularly rewarding value to users of a communication network such as the internet.

Providers of communication networks such as internet based answer or knowledge services wish to encourage users of the service to submit queries or questions and in particular to encourage uses of the services to submit high quality questions or queries.

At present there is no satisfactory method by which this can be achieved.

It is therefore an object of the present invention to provide a method of rewarding value which will go at least some way towards meeting the foregoing requirements in a simple yet effective manner or which will at least provide the public with a useful choice.

Accordingly, the invention consists in a method of rewarding value comprising the steps of inviting users to a communications network to submit queries to an answer providing service for a fee, determining the quality of the query, and offering or providing a payment to the user dependent on the quality of the query.

Preferably the payment to the user comprises a refund of all or part of the fee.

Preferably the refund is in money or monies worth.

Preferably the quality of query is assessed by one or more persons.

Preferably the communication network comprises or includes the internet

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawings in which,

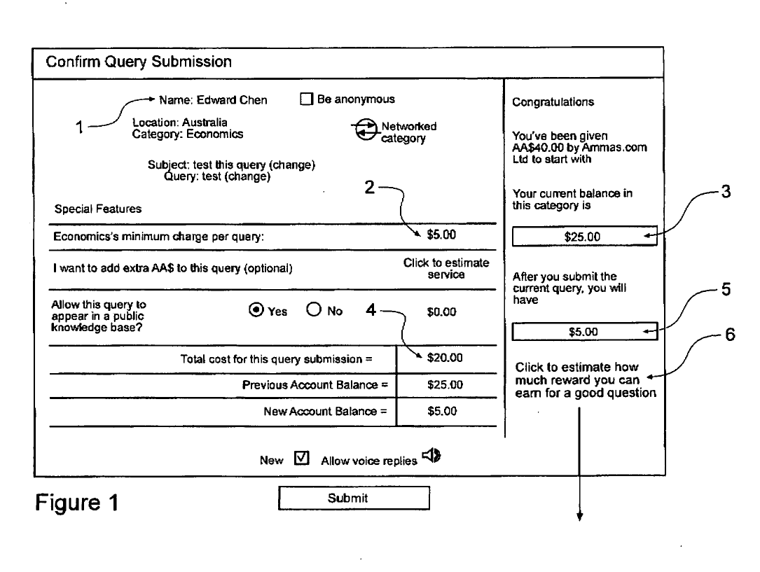

FIG. 1 is a diagrammatic representation of a query submission confirmation page usable in the method of the invention,

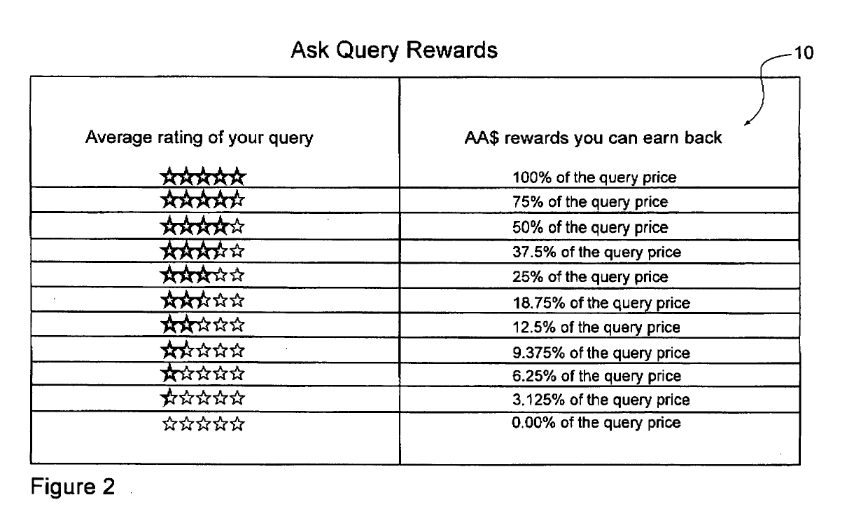

FIG. 2 is a potential query reward schedule usable in the method of the invention, and

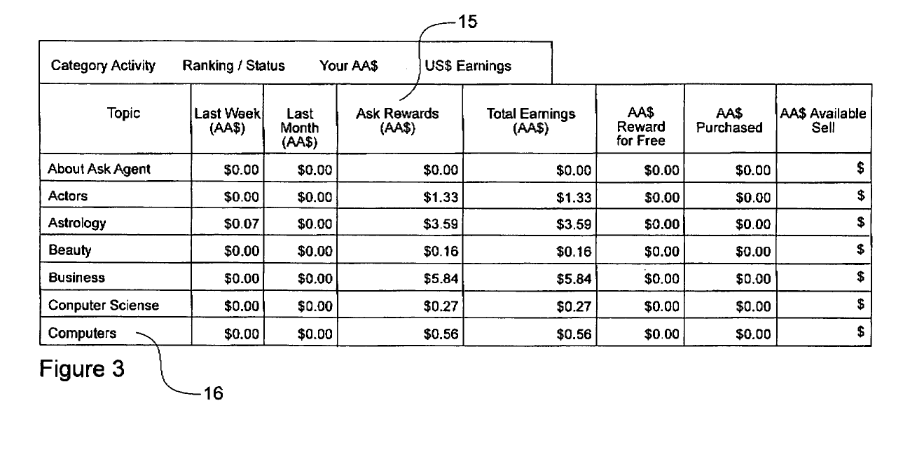

FIG. 3 gives an example of the type of reward that could be offered.

Referring to the drawings FIG. 1 shows a form which can be used to confirm a submission made to a knowledge or answer providing service on a communication network such as the internet. A query form can be provided, for example, of typical type. In the query submission confirmation form there may be, for example, a space 1 to indicate the name of the person making the submission, an indication at 2 of the minimum charge per query, an account balance at 3, a cost for the present query submission at 4, and at 5 the account balance after the query is entered.

A further panel may be provided at 6 to indicate to the potential or actual user an estimate of how much reward can be obtained for a good or high quality question. The reward can be, for example, a refund or all a part of the fee and can be in money or monies worth such as, for example, a “currency” particular to the answer providing service.

Other features can be included such a facility to add payment at 7, for example, to increase the priority of the query and the option at 8 to allow or prevent the query from appearing on a publicly accessible knowledge database, in particular, a database run by the provider of the knowledge or answer service.

Clicking panel 6 in the known manner will bring up page or panel 10, for example, as shown in FIG. 2. Accordingly, if the query or question is rated, for example, on a star scale as shown in FIG. 2, a five star rating could return 100% of the fee for submitting the query down to 0% for a zero star rating. In the example shown rewards at the lower end of the scale have less difference per step than those at the upper end of the scale. This is to encourage high quality queries. The five star rating system allows eleven steps by utilising half star steps.

The rewards or refunds shown in panel 10 are of course, illustrative only.

As a practical example referring to FIG. 3 the column 15 headed “Ask Rewards” shows refunds provided to a user for questions in various areas indicated in column 16.

The quality of the query can be rated by one or more persons who sit as a panel to review the questions.

This person or persons could be regarded as a spontaneous third party jury to whom the questions are submitted and they then provide a rating to the question using, for example, the five star rating system as shown in FIG. 2.

Thus it can be seen that a method of rewarding value is provided which has the advantage that submitters of questions or queries to an answer providing service can be encouraged to provide questions of high value or quality so as to obtain a reward for example, a part or all of the fee for submitting the question.

Throughout the description and claims of this specification the word “comprise” and variations of that word, such as “comprises” and “comprising”, are not intended to exclude other additives, components, integers or steps.

1. A method of rewarding value comprising the steps of inviting users to a communications network to submit queries to an answer providing service for a fee, determining the quality of the query, and offering or providing a payment to the user dependent on the quality of the query.

2. A method as claimed in claim 1 wherein the payment to the user comprises a refund of all or part of the fee.

3. A method as claimed in claim 1 wherein the refund is in money or monies worth.

4. A method as claimed in claim 1 wherein the quality of query is assessed by one or more persons.

5. A method as claimed in claim 1 wherein the communication network comprises or includes the internet.

6. A method as claimed in claim 2 wherein the refund is in money or monies worth.
